(19) United States
(12) Patent Application Publication
(10) Pub. No.: US 2024/0051823 A1
(43) Pub. Date: Feb. 15, 2024

(54) CARBONIZATION AND PYROLYZATION METHOD AND SYSTEM

(71) Applicant: Dops B.V., VELSEN-NOORD (NL)

(72) Inventor: Wiebe Feije PRONKER, ROELOFARENDSVEEN (NL)

(73) Assignee: Dops B.V., VELSEN-NOORD (NL)

(21) Appl. No.: 18/270,121

(22) PCT Filed: Jan. 10, 2022
(86) PCT No.: PCT/EP2022/050347

§ 371 Date: Jun. 28, 2023

(30) Foreign Application Priority Data
Jan. 11, 2021 (EP) 21150890.8

(51) Int. Cl. C01B 3/36

(52) U.S. Cl. CPC C01B 3/36; C01B 2203/0822; C01B 2203/1628; C01B 2203/1614; C01B 2203/1235

(57) ABSTRACT

A process for carbonization and pyrolyzation of hydrocarbons containing, non-fluid materials is characterized by a continuous plug stream in shafts within a refractory structure. Within the shafts, the materials are heated by the hot inner surface of the shafts without air admitted to enter the shafts. Furthermore, the developing pyrolyze gas is led directly to combustion channels around the carbonization shafts within the refractory structure where a controlled amount of air or oxygen is added, partially combusting the gas, providing the heat for the process. Aim of the process is to convert different waste streams into reusable elements without CO2 emissions, to take away hazardous materials, to produce syngas, to extract hydrogen and to create a carbon rich residue fit for mining of, among others, metals, CaO and phosphor.

### FIELD OF THE INVENTION

The invention relates to conversion of hydrocarbon containing materials or products, particularly waste, into their constituting elements or small molecules by combined high temperature carbonization and pyrolyzation. Hereinafter the conversion method and system are also referred to as ProWASTE.

### Terms

Carbonization:

The anoxic heating of coal, wood, biomass, paper, plastics and other hydrocarbons or hydrocarbons containing, most solid, materials or masses such that all volatile elements are freed, either evaporated or broken down to molecules that evaporate and such that a carbon-ash mass remains.

Pyrolyzation:

The anoxic heating of hydrocarbons to temperatures that break down longer molecules into volatile components and/or volatile components into short chain molecules or the constituting elements.

### Prior Art Discussion

Many pyrolyzation and carbonization processes exist already or are described in the public domain. To describe what ProWASTE discriminates, these prior art processes are described on the basis of common properties which group those prior art processes or methods in different aspects in which they differ from the ProWASTE process.
There are prior art pyrolyzation processes that are based on batch wise processing of a certain amount of material from its starting composition to a final or semifinal end state and without new material entering into the process during processing. The ProWASTE process is characterized by a continuous or semi-continuous plug stream with new material being fed into the process continuously or intermittently on one side of a reaction channel or shaft and with a residue leaving the process continuously or intermittently at the other side of the channel or shaft.
There are prior art pyrolyzation processes where air or oxygen is admitted to or injected directly into the process in direct contact with the pyrolyzing and carbonizing mass in order to partial incinerate the pyrolyzing and carbonizing mass in order to provide the necessary heat. This leads to partial incineration of specifically the carbon fraction of the carbonizing mass.

The ProWASTE process is characterized by that the necessary heat for heating up is added to the pyrolyzing—carbonizing process indirectly, by conduction and radiation, from the material that shapes the containing shafts or channels in which the process takes place. Furthermore, that oxygen or air is added to the pyrolyze gas downstream of the carbonizing process in a way that no oxygen can reach the solid fraction of the carbonizing mass.
There are prior art pyrolyzation processes where heat is added indirectly through the wall of the vessel containing the process mass where this channel or vessel, or at least the heat exchanging part of the vessel, is made out of metal. These processes are characterized by relatively low (below 500° C.), intermediate (up to 700° C.) or medium high (up to 900° C.) pyrolyzation temperatures, leaving many shorter or persistent hydrocarbon chains intact.
ProWASTE is characterized by the use of a refractory material to form the pyrolyzation/carbonization shaft(s) or channel(s), creating the possibility to rise the temperature of the carbonizing mass to temperatures above 900° C., more specifically to temperatures around 1150° C. ProWASTE is further characterized by that the temperature of the pyrolyze gas is increased to even higher temperatures of e.g. 1500° C. or higher through partial combustion by adding oxygen or an oxygen containing gas to the pyrolyze gas before the gas leaves the refractory structure and thus the process.
There are prior art pyrolyzation processes where heat is added to the pyrolyzing and carbonizing mass by an additional medium which is mixed with the pyrolyzing and carbonizing mass. This medium can be fine grained like sand or coarse, consisting of pebbles or ceramic or metal balls. This additional medium is heated outside direct contact with the pyrolyzing and carbonizing mass in a separate compartment or furnace and either recycled or processed once through.
The ProWASTE process again is characterized by that the necessary heat for heating up is added to the process indirectly, by conduction and radiation, from the material that shapes the containing shafts or channels in which the process takes place.
There are prior art pyrolyzation processes that use auger reactors where a screw or other transporting mechanism drives the pyrolyzing and carbonizing mass through a pipe or channel, heated from the outside or by mixing with an additional medium as described above.
ProWASTE is characterized by a plug stream type reactor where the pyrolyzing and carbonizing mass is pushed through from one end, whether or not assisted by gravitational forces but without a transporting mechanism within the reactor itself. It is also characterized by the fact that the volume of the carbonizing mass can reduce during the carbonization process but that the volume loss is filled continuously by adding new material to the process such that the channel or shaft remains completely filled up. This can result in a higher plug stream velocity at the entry side of the carbonization channel and a lower plug stream velocity in the downstream section of the channel.
There are prior art pyrolyzation processes that use (different forms of) fluidized bed reactors, like bubbling bed reactors, mixing bed reactors or entrained flow reactors. These types of reactors create fast mixing conditions and fast heat and gas exchange. They make use of high flow velocities for the gas fraction in the reactor and have short residence times and/or high re-circulation folds. They have, however, serious limitations with respect to size and weight ranges and size and weight distribution of the solid mass particles. Fluidized bed reactors have difficulties to treat larger and heavier parts, specifically in a mixture with lighter parts and when heavier parts do not disintegrate during the process.
ProWASTE is characterized by a plug stream type reactor where a mixed solid mass is led through the reactor where heat exchange is slow, created by radiation and conduction. ProWASTE is further characterized by low gas stream velocities and is very tolerant for uneven distributions of size and/or weight of the solid parts in the feed mass.
Then there are prior art processes that pyrolyze more fluid or (semi) liquid materials or mixtures, often containing larger amounts of water. These types of pyrolyze reactors are often pipe reactors, and often under high pressure.
ProWASTE is characterized by a dry or semi dry solid material stream in one or more shafts or channels under close to atmospheric pressure.
Most prior art processes have in common that the highest temperature the pyrolyze gas reaches is close to or equal to the highest temperature reached within the solid fraction in the process.
ProWASTE is characterized by a significant temperature increase for the pyrolyze gas fraction after leaving the carbonization channel. Both the final and/or highest temperature of the solid carbonized mass and the temperature profile of the pyrolyze gas are controlled within largely independent, pre-chosen narrow temperature bands.

Another group of processes of prior art are those used for coke making. In fact, coke making as implemented for the iron and steel industry can be considered as pyrolyzing and carbonizing coking coal, releasing all volatiles from the coal input. They resemble the ProWASTE process as they use a refractory construction to heat up the coal mass and they reach a high final process end temperature for the solid mass (the coke) of circa 1150° C. Two forms of coke making are widely used:
By-product coke making where the coal is batch wise pyrolyzed in narrow rectangular chambers, not channels, and where the pyrolyze gas (coke gas) leaves the carbonizing mass relatively cold (depending on the stage of the process) and is quenched immediately after leaving the coking chamber.
Heat recovery coke making where coal is batch wise pyrolyzed in mostly very large chambers, also not channels, and where air is admitted partly in the coking chambers, partly in combustion channels around the coking chambers and partly thereafter such that all pyrolyze gas (coke gas) is burned. The resulting excessive heat is subsequently led to steam boilers to produce high temperature steam.

Both those processes differ from the ProWASTE process, separate from their application, in that those processes are batch wise, the pyrolyzing/carbonizing coal mass remains stationary during the process in chambers instead of moving through channels or shafts. The by-product coke making differs too in that the coke gas is quenched immediately after leaving the coking chamber. The heat recovery coke making differs too in that all coke gas is fully incinerated before leaving the process.
In coke making, also shaft reactor coking configurations are proposed but never came to (wide spread or lasting) application. When all patents in this field are reviewed, processes differ from ProWASTE in that the processes are executed batch wise and not (semi-) continuously in a plug stream, or in that the produced off gas is led directly out of the reactor or incinerated completely within the reactor, or in that shafts are operated alternatingly in combined operation instead of independently, or in that “shafts” are, with respect to their cross section, more like flat vertical chambers, or in a combination of those aspects.
ProWASTE instead, apart from a different field of application, is characterized by channels, shafts or tunnels, in which the material is processed continuously, with continuous feeding and continuous offloading, and where a single channel can be operated self-contained, independently of the presence of more or adjacent channels. Furthermore, ProWASTE is characterized that the pyrolyze gas is combusted only partially within the process, but leaving between 50% and 75% of the heating value of the gas untouched.

### SUMMARY OF THE INVENTION

This invention provides a process and describes a possible embodiment for treating biomass, hydrocarbons containing residual materials from other processes, hydrocarbons containing end-of-live components, articles or products and/or all sorts of (semi-) dry waste streams, including paper and plastics, thermo-plastic and thermo-hardening, and any mixtures of the mentioned materials, including any contaminants like metals or metal parts, glass, sand, stone, gypsum etc., whenever present. The description below gives a proposed embodiment for the process.

### BRIEF DESCRIPTION OF THE DRAWING

Embodiments of the invention are illustrated in the attached drawing, wherein:

FIG. 1 shows an embodiment of a cross section through carbonization channel and refractory structure;

FIG. 2 shows an embodiment of a cross section through multiple carbonization channels within one build-up refractory structure;

FIG. 3 represents a cross section through possible embodiment of ProWASTE reactor; and

FIG. 4 is an embodiment of a cross section top of reactor showing the way a non-sticking layer can be inserted between the waste and the refractory structure.

### DESCRIPTION

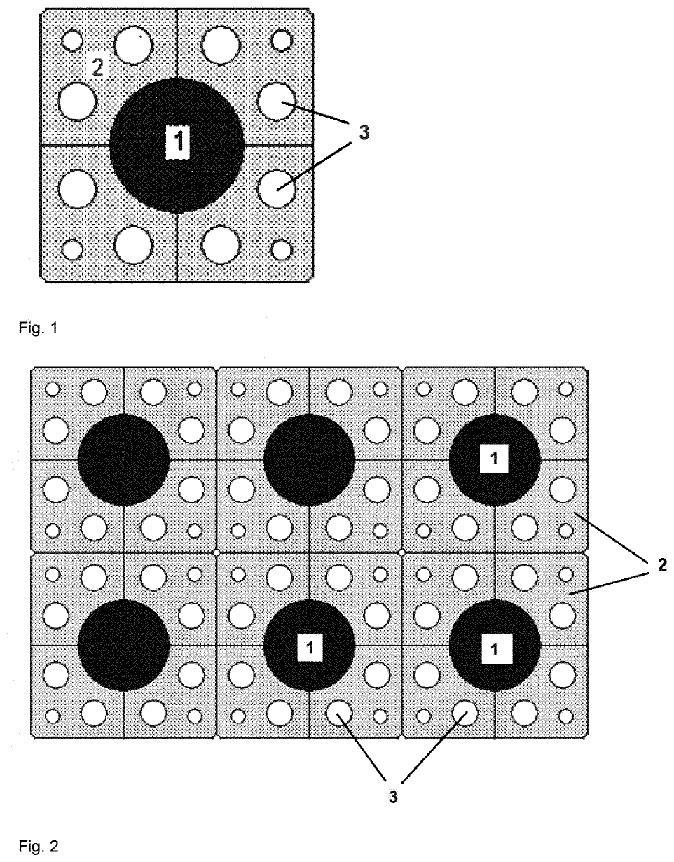

FIG. 1 presents a possible cross section through one carbonization channel, perpendicular to its length axis. In this figure:

[1] Pyrolyzing and carbonizing mass within a circular carbonization channel or shaft.

[2] Refractory structure forming the channel. In this embodiment, the refractory is split in four segments in cross section. The segments are to prevent high stresses and fracturing during heating up or cooling down.

[3] Combustion channel around the carbonization channel. In this embodiment, eight combustion channels are grouped around a single carbonization channel.

The pyrolyze gas released during the carbonization process is led directly to the combustion channels. Within the combustion channels, this pyrolyze gas is partially combusted, generating enough heat to heat up the carbonizing mass and to make up for heat losses to the outside world.

FIG. 2 presents a possible cross section through multiple parallel channels. Multiple channels are better with respect to the conduction of the heat towards the centerline of the channels. In very large diameter channels, this would take too much time, slowing down the reaction processes and leading to the need to lower the plug stream velocity and to little gain in the amount of matter that can be processed per unit of time.

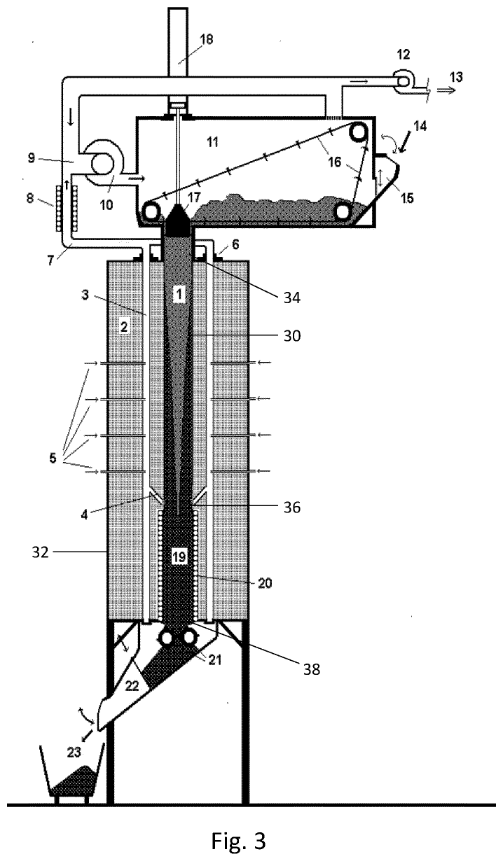

FIG. 3 presents a cross section along the length axis of the carbonization channel of a possible embodiment for a single vertical shaft ProWASTE reactor. In this figure: [1], [2] and [3] are again the carbonization channel, the refractory structure and a combustion channel.

[4] Is the direct connection between the carbonization shaft and the combustion channels. The pyrolyze gas develops within the carbonization channel and trickles through the porous carbonizing and partially already carbonized mass downstream (the upstream side is closed off and has equal or higher pressure) towards these connection channels and subsequently towards the combustion channels [3]

[5] Oxygen injection points in the combustion channels at different levels in the refractory structure. The (sub-stochiometric) amount of oxygen determines how much of the pyrolyze gas is combusted and therewith how much heat is added to the process. This shall be an amount such that all pyrolyze gas reaches a temperature of e.g. 1500° C. or more and such that the carbonizing mass in the carbonization channels reaches a temperature of 900° C. or more. The amount of heat necessary is determined by the heat capacity of the input mass and by the amount of energy necessary for decomposition of the solid materials and for the evaporation of the volatile components. It is also determined by the heat losses to the outside world and thus by the amount of insulation around the refractory structure. With the heights at which oxygen is injected into the combustion channels, the vertical heat profile through the refractory structure can be controlled, giving more control over the carbonization/pyrolyzation process. Instead of oxygen, air could be used to (partial) combust the pyrolyze gas. This will lead, however, to dilution of the pyrolyze gas with nitrogen. This could limit the use-options for the gas.

[6] Connection between combustion channel in the refractory structure and ducting pipe work.

[7] Ducting pipe work to lead the partially combusted pyrolyze gas to the next step in the process. This can be a pre-heater/dryer for the input material, a scrubber or other gas treatment facility, a baghouse, a chemical conversion unit or any type of burner or a flare.

[8] A cooling section within the pyrolyze gas ducting. This cooling section can be placed as close as possible to [6], the connection between the combustion channel in the refractory structure and the ducting pipework, or further downstream in the ducting pipework.

[9] The still hot pyrolyze gas can be mixed with a recirculation flow of same gas which is already used to dry and pre-heat the input material. This would lower the gas temperature before it enters the pre-heating and drying section but multiplies the volume for drying and pre-heating. Too high pre-heating temperatures can be avoided this way, still using all heat present within the pyrolyze gas.

[10] Ventilator to drive the recirculating gas flow. This ventilator too maintains a pressure difference between the input side of the carbonization channel (higher pressure) and the combustion channels (lower pressure). This prevents pyrolyze gas leaving the process without passing through the high temperature combustion channels.

[11] Pre-heat and dry box. Within this box, the heat content of the pyrolyze gas (and recirculation gas) can transfer to the solid input material to pre-heat and dry the input material before it enters the carbonization channel. This box can have different shapes and dimensions and can be equipped with mechanisms to better mix the pre-heating and drying material and the gas flow (like e.g. mixers or rotating drums). Basically, a counter movement is created between the solid material on the one hand and the gas flow on the other hand.

[12] Exhaust ventilator, providing pressure for following gas treatment steps where necessary and maintaining a slight under-pressure (below atmospheric) for the full gas system of the ProWASTE reactor, preventing any gas leakages from the reactor to the outside world.

[13] Output of the pyrolyze gas from the ProWASTE reactor and connection to a subsequent process step for the released gas. This next step can be a scrubber or any other gas cleaning facility (like an electrostatic precipitator or baghouse), it can be a de-sulphering unit, a chemical conversion unit, a gas separation unit or any type of burner or a flare.

[14] Input of the material to be processed in the reactor. With the pre-heat and dry box [11] wet components (up to about 25% weight of water) can be dealt with without slowing down the process in the carbonization shaft.

[15] Lock-box or gate to prevent gas escaping from the process or air entering into the process. The two sluice gates (in the example a slide valve and a hinged valve) open only one at a time.

[16] Within the pre-heat and dry box, some sort of transporting mechanism moves the input material towards the entry point of the carbonization shaft. In this example, a double-chain conveyor is depicted.

[17] Entry of the carbonization channel, closed off by a piston or plunger which lifts intermittently to let new material into the channel. Subsequently, the piston or plunger pushes the material downwards into the channel, compacts the newly entered material and pushes the whole column of pyrolyzing and carbonizing mass downwards through the carbonization channel. Gas from the dry-box which enters the carbonization channel dung the lifting of the piston comes out again through the combustion channels and back into the dry-box, driven by [10]

[18] Hydraulic or pneumatic cylinder or other lifting and pushing mechanism (e.g. electrical driven ball screw) for lifting the piston or plunger to let new material in into the carbonization channel and for pushing down the piston, for compacting the newly entered material at the entrance of the combustion channel and for pushing it through the channel (in case of a vertical shaft assisted by gravity).

[19] The fully carbonized remnants of the input material at the end of the carbonization channel. In this embodiment, a cool down section is foreseen as an extension directly in line with the carbonization channel.

[20] Cooling jacket around the cool down section of the carbonization channel. Herewith, hot water and/or (high quality) steam can be generated.

[21] Stopper—breaker rolls. In this embodiment toothed drums or axles that hold up the carbonized and carbonizing mass within the cooling section and by this within the carbonization channel. The rolls also provide the resistance for the piston or plunger [17] to exert its compaction force.

[22] Lock room to prevent gas exiting from the process or air entering the process during discharge of the carbonized residue.

[23] Discharged carbonized residue. Due to the pyrolyzation/carbonization process, the volume of residue will be less than the original input material. Due to the high carbonization temperature (>900° C.), the residue will be free of any hydrocarbons and many other polluting elements.

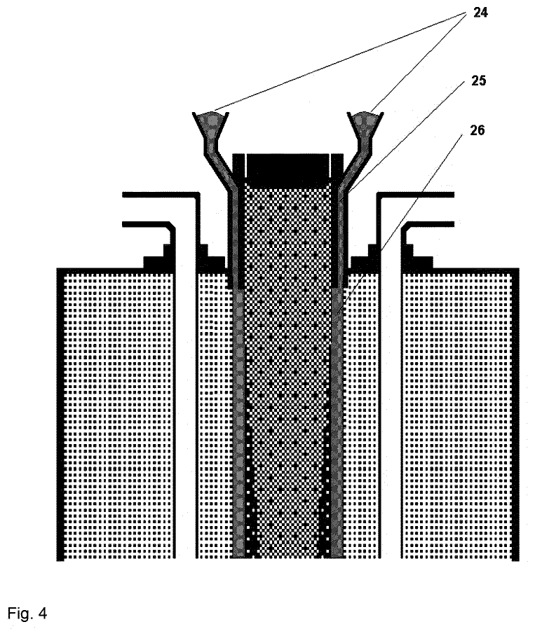

FIG. 4 presents a detail of the cross section of the top of a possible embodiment along the length axis of the carbonization channel for a special configuration where an anti-clogging layer is added to the waste stream around its circumference. In this figure:

[24] Buffer or shute for the anti-clogging material that is inserted between the waste and the refractory structure. The material can be of any type, as long as it doesn't melt or reacts in a sticking way under the conditions in the carbonization channel. It is preferred to use a material with good heat conducting properties. An example material could be part of the (grinded) carbon fraction from the solid residue which would recirculate in the reactor but doesn't add complexity to the reactions and residual material.

[25] Guideway to bring the anti-clogging material to and enter it into the combustion channel. Aim is to distribute the material evenly around the circumference of the carbonization channel. A dozing mechanism and a sealing valve (e.g. a zellenrad gate) can be included into the feed of the anti-clogging material.

[26] The anti-dogging layer around the charge of the carbonization channel. The thickness of the layer can be controlled by the geometry of the entry and/or by a dosing mechanism in the feed. The thickness will increase when the charge of the combustion channel compacts due to the pyrolyzation/carbonization processes.

[30] The reaction zone for pyrolization/carbonization defined by the heat conducting walls/refractory structure [2].

[32] The housing of the reactor system having the refractory structure [2] defining the reaction zone [30], the plurality of combustion channels [3] and the various inlets and outlets for the feedstock, anti-clogging material, the gas and residue.

[34] The feedstock inlet where the raw material enters the reaction zone [30]

[36] The gas outlet at the gas discharging position where pyrolyze gas is removed from the reaction zone [30]

[38] The solid outlet at a solid discharge position downstream of the gas outlet [36] where the solid residue leaves the reaction zone [30].

Application

The ProWASTE process can be used to process, among others, the following waste streams:
So called Mixed Municipal Residual Waste;
Any type of dry or semi dry biomass, without or with pollution with sand, stones, plastics or any other materials;
De-watered sewage sludge;
Mixed toxic waste from households or small companies;
Mixed waste streams as left-overs from train or bus deconstructions;
(Possibly contaminated) mixed hospital waste;
Mixed paper and/or plastic waste streams that cannot be recycled properly in another way;
Hydrocarbons containing mixed waste streams and residues from other processes;
(Contaminated) heavy crude or tank cleaning residues;
Soils, heavily polluted with oil, tars or other hydrocarbons;
Tar sands;
Car tires;
End of live electrical and/or electronic compliances, computers, instruments and equipment;
PCB's, cable booms, connectors;
End of live solar panels;
End of live windmill blades;
GFRP or CFRP ship or yacht hulls or aircraft components;
Aircraft interiors and any composite containing aircraft components;
End of live artificial turf from sport fields;
Car-recycling residual waste streams;
Mixed textile products, clothing, rags and shoes;
Carpets and matrasses;
Or any mixture or combination of two or more waste streams as described above.

Basically, all solid or semi-solid waste streams with a certain percentage of no matter what type of hydrocarbons can be processed successfully in a ProWASTE reactor with proper dimensions. The percentage of hydrocarbons can be much lower than necessary for incineration within a waste incineration facility for the following reasons: The solid mass remains at a lower temperature compared to the temperature of the gas fraction which is burned, there is no nitrogen (in the combustion air) that needs to be heated up and because the dimensions of the refractory structure (and therewith the heat losses) are smaller than the furnace dimensions of an incineration facility with comparable throughput capacity.

Start Up

To start a ProWASTE reactor, the refractory structure needs to be heated up to a minimum pyrolyzing temperature to create sufficient pyrolyze gas from the initial load within the carbonization channel for further heating up and for maintaining the proper process conditions. The minimum temperature depends on the composition of the input material. Heating up can be accomplished by pre-heater burners in the combustion channels (e.g. by injecting a burning gas into the channels). Another way to start up a facility is by (possibly partial) incineration of a hydrocarbon rich starting load within the carbonization/pyrolyzation channel by temporary air or oxygen injection into the upstream side of the carbonization/pyrolyzation channel. Electrical preheating of the refractory structure is of course a third option.

Advantages

The advantages of the ProWASTE process are many. To name them:
It accepts a very wide range hydrocarbon containing dry or semi dry waste components.
The presence of (mixed) metal parts, of stones, sand, chalk, gypsum, glass, etc. is not a problem for the process.
A mixture of large chunks and fine particles can be well accepted in the process.
Humidity or wet components are no problem (low level residual heat is used for drying).
Low temperature volatiles in the input material do not present a problem for the process. They come down from the drier with the syngas (from which they can be scrubbed if necessary) or are cracked down and pyrolyzed within the process.
The process runs at low pressure (close to atmospheric) with low gas stream velocities which simplifies any embodiment and limits risks of leakages.
The process runs at low solid material stream velocities which limits wear and tear.
Low noise levels from the embodiment due to low material and gas flow velocities and due to low pressure differences.
The process is easily scalable and extendable, either in the size (length and diameter) of a single reaction channel or by placing more reaction channels in parallel, or both.
The carbonized residue is clean from any volatiles, tars or any other hydrocarbons and forms an ideal feed material for urban mining: Metals will not oxidize during the process. Carbon, CaO, P and other ash components and metals can be separated in further process streams.
Certain metals (e.g. Zn, Cd) evaporate during the process and come with the pyrolyze gas. They can be separated by controlled condensation during the cooling down of the pyrolyze gas.
Fluorine, chlorine, bromine, iodine and sulphur come as elements or as hydrides in the syngas and are easily scrubbed in a wet gas scrubber.
The resulting syngas is a high value feedstock for chemical industry. It will consist mainly of hydrogen (around 60%) and carbon monoxide (around 30%), depending on the feed material of the reactor.
All already present tars, PACs, PFAS, dioxins and all other often toxic and persistent hydrocarbons will be broken down. No new will be formed.
No formation of nitric oxides (NOx).
Very low levels of carbon dioxide (CO₂) are formed during the process. With biomass as feedstock and with the extraction and deposition of the carbon from the carbonized mass, the carbon footprint of the process is even negative.

Disadvantages

Disadvantages are limited. A few are:
It is a relative slow process due to the necessary heat transfer by radiation and conduction. It therefore requires a high process temperature and thus good insulation of any embodiment.
Due to the necessary high temperature of the process and the heat capacity of the refractory structure, the process cannot be started and stopped quickly. The process is best operated on a continuous 24/7 basis.
Valuable intermediate products like oils or tars ca not be separated from the pyrolyze gas.

The process according to the invention may be described by the following clauses:

1. A process for the combined carbonization and pyrolization of biomass, hydrocarbons containing residual materials from other processes, hydrocarbons containing end-of-live components, articles or products and/or all sorts of (semi-) dry waste streams, including paper and plastics and any mixtures of the mentioned materials, with the following characteristics:
The biomass, residues, components and/or waste are heated anoxic in a (semi-) continuous plug stream in one or more enclosed and closed off shafts or channels [1], called carbonization channels, within a refractory structure [2];
The biomass, residues, components and/or waste are heated by the hot inner surface(s) of the refractory structure forming the carbonization channel;
The biomass, residues, components and/or waste are heated gradually, from the inner surface of the carbonization channels towards the center line of the channels, to high temperatures, of 900° C. and above, more specifically to temperatures around 1150° C., resulting on the one hand in a pyrolyze gas formed by evaporation of volatile components and the decomposition of hydrocarbons and other materials which decompose emitting volatile components and on the other hand a carbon rich residue, a mixture of those components in the biomass, residues, components and/or waste that do not evaporate or decompose into gaseous components at those temperatures;
The resulting pyrolyze gas escapes the carbonization channel or channels by openings in the channel surface at a hot, downstream location in the refractory structure forming the channel(s) [4];
The resulting pyrolyze gas is led directly, remaining within the refractory structure and without further pressurization, treatment or cooling down, to combustion channels [3] within the same refractory structure that form the carbonization channel(s) containing the biomass, residues, components and/or waste;
Within those combustion channels, the pyrolyze gas is partially, e.g. for 50% or less, combusted by injecting an oxygen containing gas (e.g. air) or, more particularly, by injecting oxygen such that the temperature of the gas stream rises further to temperatures above 1500° C., more specifically to temperatures above 1800° C., further breaking down all volatile components into constituting elements or small molecules;
The superheated pyrolyze gas in the combustion channels heat up the refractory structure, providing the heat to heat up and carbonize the newly fed biomass, residues, components and/or waste within the carbonization channels and making up for any heat losses to the outside world.

2. A process for the combined carbonization and pyrolization of biomass, residues, components and/or waste according to clause 1 where the gas pressure in the carbonization channel(s) of the biomass, residues, components and/or waste and in the combustion channels is about equal and relatively low, between 0.7 and 2 bar, more specifically around or just under atmospheric. The pressure in the combustion channels will always be equal to or below the gas pressure in the carbonization channels. A small pressure drop can develop resulting from the flow resistance in the connecting channels or orifices between the carbonization channel(s) and the combustion channels.

3. A process for the combined carbonization and pyrolization of biomass, residues, components and/or waste according to clause 1 where the plug stream velocity in the carbonization channels of the biomass, residues, components and/or waste is very low, between 0.25 meter and 2.5 meter per hour. The optimal plug stream velocity is determined by the diameter and length, or width and height and length of the carbonization channels on the one hand and the specific heat and the heat conductivity of the biomass, residues, components and/or waste on the other. The plug stream velocity can be higher at the entry side of the carbonization channel or channels relative to the downstream side of the same channel or channels when the carbonizing mass loses volume. The residence time of the carbonizing mass within the carbonization channel or channels shall be such that the intended high carbonization temperature is reached throughout the full cross section of the carbonization channel(s).

4. A process for the combined carbonization and pyrolization of biomass, residues, components and/or waste according to clause 1 where the temperature profile along the length axis of the channel of the refractory structure forming the carbonization channel(s) is regulated by the location (more upstream and/or more downstream along the combustion channel) and by the amount of oxygen injected [5] into the pyrolyze gas in the combustion channels that surround the carbonization channel(s).

5. A process for the combined carbonization and pyrolization of biomass, residues, components and/or waste according to Clause 1 where the upstream side of the carbonization channel or channels is closed off by a lock chamber, providing two (sets of) gates, slides, doors or valves, each of which opens only when the other (set of or) gate, slide, door or valve is closed. The lock chamber [15] serves to let fresh material into the entry side of the carbonization channel or channels and to prevent or limit (pyrolyze) gas escaping from the carbonization channel(s) or gas (e.g. air) entering into the carbonization channel(s).

6. A process for the combined carbonization and pyrolization of biomass, residues, components and/or waste according to clauses 1 and 5, where the entry side of the/of each carbonization channel is formed by one or more pistons [17]. The piston(s), one for each carbonization channel, combines one or more of the following functions:
a) To prevent or limit (pyrolyze) gas escaping from the carbonization channel(s) and to prevent gas (e.g. air) entering into the carbonization channel(s);
b) To compact the biomass, residues, components and/or waste each time after a new amount is let into the carbonization channel(s);
c) To push through the biomass, residues, components and/or waste and the resulting carbonized residue through the carbonization channel(s)

7. A process for the combined carbonization and pyrolization of biomass, residues, components and/or waste according to clause 1 where the downstream side of each carbonization channel contains a breaker mechanism [21]. The breaker mechanism can be formed by rotating, possible toothed, axles or drums, by sleeves or by valves with one or more of the following functions:
d) To dose and control the amount of carbonized residue that exits the carbonization channel;
e) To form a resistive plug to prevent material falling out of the carbonization channel(s) by gravitational forces.
f) To form a resistive plug to which a piston or other mechanism can create pressure to compact the biomass, residues, components and/or waste at the entrance side of the carbonization channel;
g) To break down the carbonized mass into smaller pieces, to crumble and/or to grind.

8. A process for the combined carbonization and pyrolization of biomass, residues, components and/or waste according to clause 1 where the carbonization channel is extended, before or after a possible breaker mechanism, with a cool down section within or extending outside the refractory structure [19]. The carbonized residues of the biomass, residues, components and/or waste cool down through heat loss to the (cooled) surface of the cool down section.

9. A process for the combined carbonization and pyrolization of biomass, residues, components and/or waste according to clause 1 where the downstream side of each carbonization channel, before or after a possible cool down section and or breaker mechanism is closed off by a lock chamber [22] with double gates, such that no gas will escape from, nor enter into, the carbonization channel and/or the cool down section, while the carbonized residual mass leaves the process.

10. A process for the combined carbonization and pyrolization of biomass, residues, components and/or waste according to clause 1 where the carbonization channel is, with or without a breaker mechanism, hot-connected to a smelter/separator bath in which the carbonized mass is further heated up to melt certain components of the carbonized mass, more specifically to melt the metals within the carbonized mass to facilitate separation and/or further processing.

11. A process for the combined carbonization and pyrolization of biomass, residues, components and/or waste according to clause 1 where a dry-box [11] is constructed between the entry gate for the biomass, residues, components and/or waste and the carbonization channel and where (a part of) the residual heat of the pyrolyze gas is used to pre-dry and pre-heat the biomass, residues, components and/or waste before being transferred to the carbonization channel entrance.

12. A process for the combined carbonization and pyrolization of biomass, residues, components and/or waste according to clause 1 where part or temporarily all of the heat to heat up the refractory structure is not created by partial combustion of the pyrolyze gas but is supplemented or (temporarily) substituted by electrical heating elements within the refractory structure or within the combustion channels.

13. An embodiment for a process for the combined carbonization and pyrolization of biomass, residues, components and/or waste according to clause 1 and possibly one or more of the other claims where a non-sticking ‘anti-clog’ layer [26] is continuously added around and with the downwards moving waste. This anti-clogging layer can be a separated and prepared fraction of the solid residue that is recirculated through the reactor.

14. A process for the combined carbonization and pyrolization of biomass, residues, components and/or waste according to clause 1 and possibly one or more of the other claims where a gas is added into the carbonization channel to give more control over the carbonization process. An example of this can be steam to release more carbon from the waste into the gas phase in the form of CO. Another example could be methane to crack the methane to produce more hydrogen, leaving (part of) the carbon in the methane with the solid residue.

15. A process for the combined carbonization and pyrolization of biomass, residues, components and/or waste according to clause 1 and possibly one or more of the other claims where a gas is added into the combustion channels to have better control over the final composition of the syngas. An example can be steam to enhance the hydrogen content of the syngas making use of the watergas-shift-reaction. Another example can be to add a combustion gas into the combustion channels to add heating power when the hydro-carbon content of the feed in the carbonization channel is too low to create enough syngas to keep the process running.

16. A process for the combined carbonization and pyrolization of biomass, residues, components and/or waste according to clause 1 and possibly one or more of the other claims where a ceramic sooth filter is integrated in the combustion channels. The sooth filter prevents possible sooth to remain a species within the syngas. By periodic oxygen injection just upstream of the sooth filter, the filter can be cleared of accreted sooth.

17. A process for the combined carbonization and pyrolization of biomass, residues, components and/or waste according to clause 1 and possibly one or more of the other claims where one or more catalyzers are integrated in the combustion channels. The catalyzer(s), depending on their nature, aid specific reactions to proceed faster within the partly combusted gas. This way, more control is possible over the preferred composition of the syngas.

1.-23. (canceled)

24. A method for the carbonization and/or pyrolyzation of a hydrocarbon comprising material, comprising:
a first feeding step of continuously or intermittently feeding a feedstock of the hydrocarbon comprising material to a reaction zone defined by heat conducting walls, at a supply position upstream of the reaction zone;
a heating step of indirect anoxic heating of the feedstock through the heat conducting walls, while displacing the feedstock downstream through the reaction zone, thereby carbonizing and/or pyrolyzing the feedstock to obtain a pyrolyze gas and a residue;
a first discharging step of discharging the obtained gas from the reaction zone at a gas discharge position downstream of the reaction zone;
a second feeding step of feeding an oxygen comprising gas to the discharged gas;
a combustion step of at least partially combusting the discharged gas with the oxygen comprising gas, thereby indirectly heating the feedstock through the heat conducting walls; and
a second discharging step of discharging the residue from the reaction zone at a solid discharge position downstream of the gas discharge position.

25. The method according to claim 24, wherein the hydrocarbon comprising material is a solid material.

26. The method according to claim 24, wherein the hydrocarbon comprising material is indirectly heated to at least 900° C.

27. The method according to claim 24, wherein the at least partially combusted gas from the combustion step reaches a temperature of 1500° C.

28. The method according to claim 24, wherein the feedstock is displaced from the supply position to the solid discharge position with a velocity in the range of 0.25-2.5 meter per hour.

29. The method according to claim 24, wherein the first feeding step further comprises feeding an anti-clogging material to the supply position of the reaction zone, such that the anti-clogging material is inserted between the feedstock and the heat conducting walls of the reaction chamber.

30. The method according to claim 29, wherein the residue is used at least partially as anti-clogging material.

31. The method according to claim 24, wherein the method further comprises pre-heating and optionally drying the feedstock with the leftover heat from the combustion step.

32. The method according to claim 24, wherein the combusted gas is subjected to a gas treatment, including desulphurization, scrubbing, gas separation or incinerating, or a combination thereof.

33. The method according to claim 24, wherein the method further comprises, before the second discharging step, a cooling step of cooling down the residue.

34. The method according to claim 24, wherein the gas pressure in the one or more combustion channels is equal to or lower than the gas pressure in the reaction zone.

35. The method according to claim 24, wherein the gas pressure in the reaction zone is in the range of 0.7-2 bar.

36. The method according to claim 24, wherein the gas pressure at the supply position upstream of the reaction zone is equal to or higher than the gas pressure at the first discharging position.

37. A reactor system for the carbonization and/or pyrolyzation of a hydrocarbon comprising material, comprising:
a housing comprising:
heat conducting walls delimiting a reaction zone, wherein the reaction zone is configured to allow displacement of feedstock, and wherein the reaction zone is configured to allow carbonization and/or pyrolyzation of the feedstock to obtain a gas and a residue;
an inlet for supplying the feedstock to the reaction zone at an upstream supply position;
a gas outlet for discharging the obtained gas from the reaction zone, wherein the gas outlet is positioned at a first discharging position downstream of the reaction zone;
a combustion channel that is in heat conducting relationship with the heat conducting walls, wherein the combustion channel comprises gas entry points configured to receive an oxygen comprising gas; and,
a connection channel connecting the gas outlet and the combustion channel, and
a solid outlet for discharging the residue at a discharging position downstream of the gas outlet.

38. The reactor system according to claim 37, wherein at least the heat conducting walls and the combustion channels are made up from refractory materials.

39. The reactor system according to claim 37, wherein the reaction zone is arranged vertically.

40. The reactor system according to claim 37, comprising two or more reaction zones parallel relative to each other.

41. The reactor system according to claim 37, wherein the reaction zone comprises more than one gas outlet for discharging the obtained gas and more than one combustion channel for combusting the obtained gas with the oxygen comprising gas.

42. The reactor system according to claim 37, further comprising a cooling system arranged at a downstream position of the gas outlet, wherein the cooling system is configured for cooling down the residue.

43. The reactor system according to claim 37, further comprising a pre-heat and dry box arranged near the inlet of the reaction zone, wherein the pre-heat and dry box is configured for pre-heating and optionally drying the feedstock by contact with the combusted gas.

44. The reactor system according to claim 37, further comprising a breaker mechanism arranged at the solid outlet.
